(19) United States
(12) Patent Application Publication
(10) Pub. No.: US 2003/0027031 A1
(43) Pub. Date: Feb. 6, 2003

(54) Fuel cell stack and method for assembling a fuel cell stack

(76) Inventors: Manfred Baldauf, Erlangen (DE); Rolf Bruck, Bergisch Gladbach (DE); Peter Buchner, Heiligenstadt (DE); Joachim Grosse, Erlangen (DE); Jorg-Roman Konieczny, Siegburg (DE); Arno Mattejat, Bubenreuth (DE); Igor Mehltretter, Buckenhof (DE); Konrad Mund, Uttenreuth (DE); Manfred Poppinger, Uttenreuth (DE); Meike Reizig, Bonn (DE); Manfred Waidhas, Nurnberg (DE); Rittmar Von Helmolt, Mainz (DE)

Correspondence Address: LERNER AND GREENBERG, P.A., Post Office Box 2480, Hollywood, FL, 33022-2480, US

(21) Appl. No.: 10/178,647

(22) Filed: Jun. 24, 2002

Related U.S. Application Data
(63) Continuation of application No. PCT/DE00/04593, filed on Dec. 22, 2000.

(30) Foreign Application Priority Data
Dec. 23, 1999 (DE) 199 62 682.0

(51) Int. Cl. H01M 8/24; H01M 2/08; H01M 8/10

(52) U.S. Cl. 429/35; 429/36; 429/32; 427/115

(57) ABSTRACT

A fuel cell stack includes at least two stacked fuel cell units which are held together by a material which has sealing and fixing properties. A method for assembling a fuel cell stack is also provided.

### CROSS-REFERENCE TO RELATED APPLICATION

This application is a continuation of copending International Application No. PCT/DE00/04593, filed Dec. 22, 2000, which designated the United States and was not published in English.

### BACKGROUND OF THE INVENTION

Field of the Invention

The invention relates to a fuel cell stack, to a method for assembling a fuel cell stack and to the use of a fuel cell stack of this type.

European Patent No. EP 0 795 205 B1 discloses a fuel cell and a fuel cell stack in which the fuel cell units are mechanically stacked and are held together via end plates with the aid of threaded bolts. Sealing lips on the individual lead-throughs, with a supporting ring as a mechanical abutment, are used as sealing material. This system is configured such that there is a direct contact between the terminal plates, which are configured as bipolar plates, and the membrane. The direct contact between the terminal plates and the membrane can cause corrosion problems.

Therefore, this conventional configuration is unsuitable for relatively high operating temperatures, as are customary, for example, in the high-temperature variant of the PEM (Polymer Electrolyte Membrane) fuel cell.

### SUMMARY OF THE INVENTION

It is accordingly an object of the invention to provide a fuel cell stack which overcomes the above-mentioned disadvantages of the heretofore-known fuel cell stacks of this general type and which is suitable for all types of PEM fuel cells.

With the foregoing and other objects in view there is provided, in accordance with the invention, a fuel cell stack, including:

at least two stacked fuel cell units;

two end plates;

two outermost terminal plates and/or two outermost bipolar plates and/or a housing; and

at least one connecting material for connecting the at least two stacked fuel cell units to one another, the at least one connecting material having sealing properties as well as fixing properties.

According to another feature of the invention, the connecting material is a thermally stable plastic.

According to yet another feature of the invention, the connecting material adhesively bonds the at least two stacked fuel cell units in a sealed manner.

According to another feature of the invention, the connecting material is an elastic elastomer or an elastomer having partially elastic sections.

According to a further feature of the invention, the connecting material is an elastomer having elastic sections and partially elastic sections.

According to another feature of the invention, the connecting material is at least partially reinforced with fibers and/or has crosslinked sections.

According to another feature of the invention, the at least two stacked fuel cell units each include a membrane and a terminal plate which do not directly contact one another.

According to yet another feature of the invention, the connecting material is formed as a supporting ring and/or a sealing ring.

According to another feature of the invention, the housing is a pressure-carrying outer housing.

According to a further feature of the invention, tie rods hold the endplates together; the at least two stacked fuel cell units have an axial supply duct; and at least one of the tie rods is guided in the axial supply duct.

With the objects of the invention in view there is also provided, a method for assembling a fuel cell stack, the method includes the steps of:

providing at least two stacked fuel cell units, two end plates, two outermost terminal plates and/or two outermost bipolar plates and/or a housing; and

connecting the at least two stacked fuel cell units to one another by using a connecting material having a sealing property as well as a fixing property.

Another mode of the method according to the invention includes sealing the at least two stacked fuel cell units by using elastic material properties of the connecting material; and fixing the at least two stacked fuel cell units by using non-elastic material properties of the connecting material.

Another mode of the method according to the invention includes sealing the at least two stacked fuel cell units with an inelastic connecting material by using a bonding process.

With the objects of the invention in view there is also provided, a method for assembling a fuel cell stack, the method includes the steps of:

providing a fuel cell stack having at least two stacked fuel cell units, two end plates, at least one casing configuration selected from the group consisting of two outermost terminal plates, two outermost bipolar plates and a housing, the at least two stacked fuel cell units being connected to one another with a connecting material having a sealing property as well as a fixing property; and

using the fuel cell stack as a HT-PEM (High Temperature Polymer Electrolyte Membrane) fuel cell stack.

In other words, the subject matter of the invention is a fuel cell stack having at least two stacked fuel cell units and at least one end plate and/or a housing and/or an outermost terminal or bipolar plate, the fuel cell units being connected to one another by a material which has sealing and fixing properties. The subject matter of the invention is also a method for assembling a fuel cell stack, in which at least two fuel cell units are connected to form a stack using a material which has sealing and fixing properties, and the use of a fuel cell stack of this type in a fuel cell system employing HT-PEM (High Temperature Polymer Electrolyte Membrane) fuel cells.

As explained above, according to one embodiment of the stack, the material also has adhesive bonding properties, so that the fuel cell units which have been connected via the material are adhesively bonded to one another and connected in a sealed manner. This means that either no further sealing pressure or only a slight sealing pressure from end plates using a clamping device is required.

The latter type of cell—or stack-internal force absorption by adhesive bonding of the cells makes it possible to use either end plates made from thin, lightweight and inexpensive material or even to omit the solid end plates altogether, in which case the outer boundary surfaces of these stacks are the terminal plates of the first and last fuel cell unit, i.e. the outermost fuel cell units of the stack.

According to one embodiment of the stack, the material is elastic, so that thermally generated changes in volume of the inelastic structural parts of the stack, such as in particular the bipolar plate, the electrode, the membrane and/or matrix can be compensated for by the elasticity of the connecting material.

According to another embodiment of the stack, the material is periodically partially elastic. This is understood as meaning that the material, in successive regions, is not continuously elastic, but rather is alternately elastic and inelastic, i.e. mechanically rigid, so that it also imparts mechanical strength to the stack. For this purpose, by way of example, regions of the material are reinforced with inelastic parts, for example with fibers. The fibers may be formed of metal, carbon, glass fibers or the like, i.e. fibers which are able to absorb tensile forces in combination with the base material. In this context, reference is made to glass fiber-reinforced plastics which can likewise be used.

Alternatively, it is also possible for materials to be deliberately crosslinked in certain localized regions, for example by what is known as radiation crosslinking. This allows the same material to periodically or in sections have elastic and inelastic properties. The inelastic regions are preferably located on the outer side of the stack.

Within the context of the invention, the elements of the fuel cell unit—such as the membrane electrode assembly and the terminal plates—are likewise connected to one another through the use of a material with sealing and fixing properties. This connection is preferably made in such a manner that there is no direct contact between a bipolar plate and the membrane and/or matrix, since there is a risk that the acid in the membrane or matrix will attack the material and/or the surface-coating of the terminal plate.

The material is preferably a plastic which is stable up to approx. 300° C. By way of example, a polymeric material which is composed of identical or different monomer units is suitable for this material. Various monomer units and additives may be present in the plastic, depending on the application in the stack. By way of example, a material which may be used is an elastomer, preferably an adhesively bonding elastomer and particularly preferably an adhesively bonding elastomer with inelastic regions and/or periodically partially elastic regions.

According to one embodiment, the plastic forms a frame element which surrounds the stack. According to another embodiment, the plastic forms supporting and/or sealing rings, which connect the fuel cell units to one another in a sealing manner at the lead-throughs of the axial ducts and/or manifolds. According to another embodiment, the terminal plates of adjacent cells are adhesively bonded to one another by the material.

Depending on the positioning, it is also possible to use different materials. As has been mentioned above, in particular, according to one embodiment, the supporting and/or sealing rings made from plastic are reinforced with metal or glass fibers.

According to a further embodiment, the stack is accommodated in a pressure-carrying external housing, so that no internal manifold is required at least for a process gas and/or the cooling medium. In this case, the fuel cell stack preferably forms a closed configuration.

With the invention, it is also possible to produce an open stack configuration if the fuel cell units are connected to one another in an only partially sealed manner. In the case of the open stack configuration with hydrogen recirculation and reformer operation, inevitable impurities mean that a gas-cleaning membrane, which is arranged, for example, in the gas feed line, is advantageous. In the open configuration, for removal of condensed liquid product water which blocks the gas diffusion layer at operating temperatures below the boiling point of water, the stack is advantageously arranged with vertically oriented active cell surfaces in such a way that the water drips out of the active cell surfaces.

According to one specific embodiment, the stack is additionally held together by tie rods and threaded bolts at the end plates, it is also possible, by way of example, for at least one tie rod to be guided through an axial supply duct.

Other features which are considered as characteristic for the invention are set forth in the appended claims.

Although the invention is illustrated and described herein as embodied in a fuel cell stack, a method for assembling it and the use of a fuel cell stack of this type, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic sectional view of a fuel cell stack according to the invention which is part of a fuel cell system;

FIG. 2 is a partial sectional view of an edge region of the fuel cell stack shown in FIG. 1;

FIGS. 3 and 4 are partial sectional views of two alternative configurations prior to assembly of the fuel cell stack according to the invention; and

FIG. 5 is a partial sectional view of a fuel cell stack according to the invention illustrating a sealing element which is configured to be alternately a fixing element and/or a sealing element.

### DESCRIPTION OF THE PREFERRED EMBODIMENTS

In the figures, parts which are identical or have the same function in each case bear identical or corresponding reference numerals. Some features of the fuel cell stack shown in the figures are jointly described without reference to a specific figure. The term stack is understood as meaning a stacked configuration of at least two fuel cell units with the associated lines and at least part of the cooling system.

The term fuel cell system refers' to the entire fuel cell installation, which has one or more subsystems. Each subsystem has at least one fuel cell unit, the corresponding supply lines, i.e. the process gas feed and discharge passages, end plates and/or a housing and/or an outermost terminal plate, a cooling system with cooling medium and cooling lines and “fuel cell stack peripherals”. These peripherals include, for example, a reformer, compressor, blower and/or heater for process gas preheating, as well as optionally further modules.

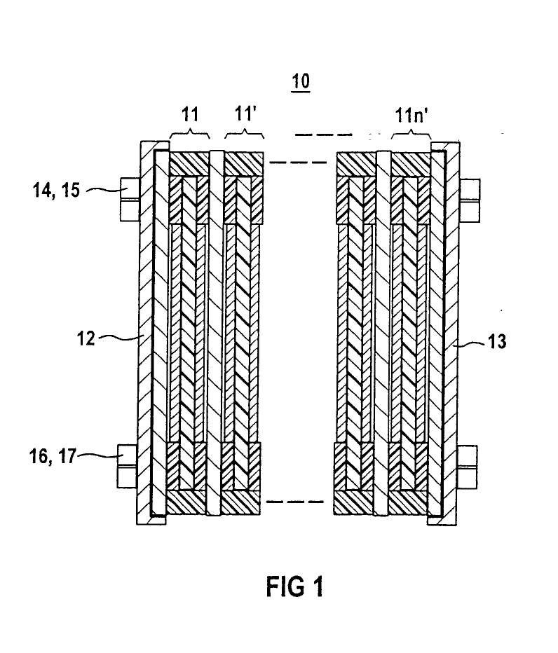

In FIG. 1, a fuel cell stack is denoted by 10. The stack includes a plurality of individual fuel cell units 11, 11′, . . . 11n′, which are stacked to form a fixed assembly. Each fuel cell unit 11, 11′, . . . 11n′ includes a membrane electrode assembly (MEA) including a proton-conducting membrane 110 which is known, for example, under the trade name “NAFION”, with electrodes 12 and 13 on both sides and also so-called terminal plates 15, which are expediently configured as bipolar plates for two adjacent fuel cell units 11 and 11′. The entire configuration is held together through the use of end plates 12 and 13 and a plurality of tie rods, of which the tie rods 14, 15, 16, 17 can be seen in the figure.

In a configuration of this type, it is important that the individual fuel cell units 11, 11′, . . . 11n′ are each individually sealed and are held in a frame. For this purpose, in the figure there is shown a material which has adapted and fixing properties and whose configuration is denoted by 20 in the figures.

The specific configuration of the material 20 is used to connect and fix the individual fuel cells 11, 11′, . . . 11n′ to one another and at the same time is responsible for ensuring a seal. The form of the material 20 may be elastic in the region 21, in order to absorb temperature-related stresses, while in the regions 22 the material is inelastic, where to a certain extent it serves as a rigid frame.

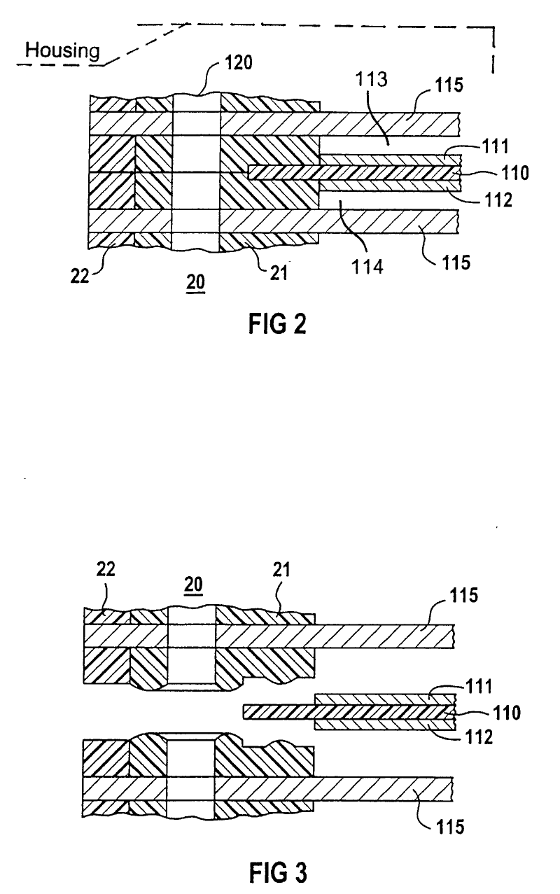

The structure of the individual fuel cell units 11, 11′, . . . of the fuel cell stack 10 can be seen from FIG. 2. Each fuel cell unit 11 includes at least one membrane 110 and/or matrix with a chemically and/or physically bonded electrolyte and two electrodes 111 and 112 which are located on opposite sides of the membrane and/or matrix. At least one electrode 111, 112 is adjoined by a reaction chamber 113, 114, which is closed off from the environment through the use of in each case one terminal plate or, for two fuel cell units together, a bipolar plate 115 and/or a corresponding edge structure. There are devices which can be used to introduce and discharge process gas into and from the reaction chamber. By way of example, an axial passage 120 for supplying the fuel cell units with process gas or cooling agents or the like can be seen.

The configuration of the sealing device 20 can be seen in detail in particular from FIG. 2. In the inner region, there is a seal 21 which forms an elastic seal and is deformed in the process of sealing. In the outer region, there is a seal 22 which has fixing or securing properties and is not deformed. Stability of the configuration is achieved by this configuration, in particular by the fixing seals 22.

Heavy inflexible plates, through the use of which the pressure from the tie rods is transmitted to the edge lengths of the fuel cell units, have been used as end plates. By using the sealing material according the invention as described herein, it is for the first time possible to use more lightweight and thinner end plates as a result of “cell-internal force absorption.” If appropriate, separate components of this type can even be dispensed with altogether.

FIGS. 1 and 2 show a closed configuration of the fuel cell stack. For an open configuration—with a vertical configuration of the individual fuel cell units 11, 11′ of the fuel cell stack 10—corresponding openings are to be provided in the lower region.

To assemble a fuel cell stack as shown in FIG. 2, seals 20 made from the material with deformable regions 21 and nondeformable regions 22 are applied, for example by vulcanization, to each of the bipolar plates 115. The actual MEA is inserted between two such configurations of bipolar plates 115 with the seals 21. Sealing requires a force which deforms the elastic regions 21 of the seals 20 to such an extent that the inelastic regions 22 bear against one another. The sum of the distances fixed in this way results in the total height of the stack.

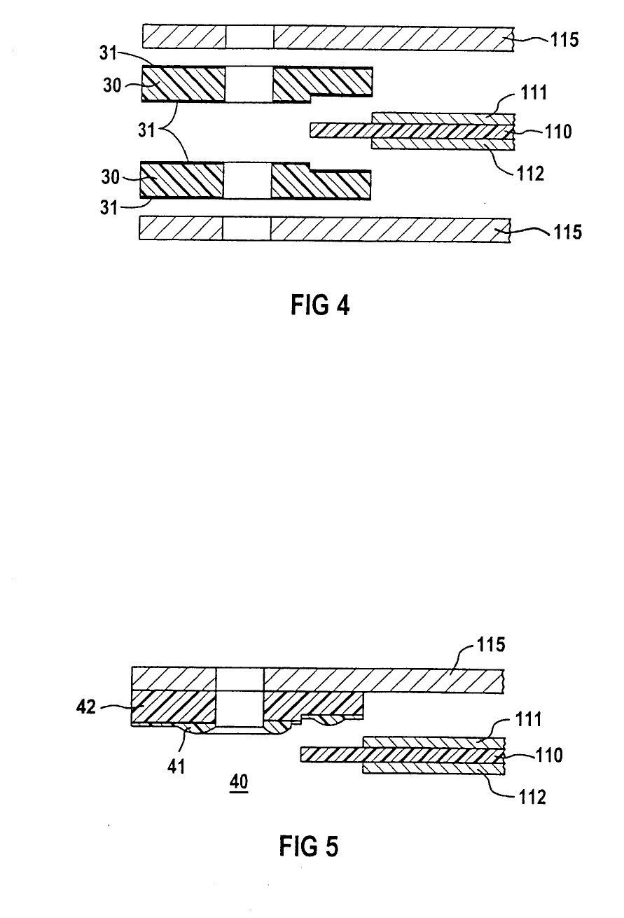

FIG. 4 shows that, for sealing purposes, adhesively bonding surfaces 31 are in advance applied to the seals, in particular in the case of fixing seals 30. If appropriate, the seals are provided with adhesively bonding surfaces on only one side. In this way, it is likewise possible to achieve a sealing interconnection and in this case also a fixing interconnection of the individual fuel cell unit and therefore, when using bipolar plates, an interconnection of an entire fuel cell stack 10.

FIG. 5 makes it clear that a sealing element 40 may have alternately fixing and sealing properties. The element 40 has an outer region 41 which is preshaped, for example, in the manner of a bead and has elastic properties and is suitable for the compressive clamping of the MEA including a membrane 110 and electrodes 111, 112. By contrast, the region 42 which is directed toward the terminal plate has fixing properties.

These properties may be effected, for example, by incorporating fibers of other materials, for example metallic materials, or, in the case of certain polymers, by radiation crosslinking.

With the elements shown in FIG. 5, it is possible, given a suitable layered configuration, for the sealing of the MEA, on the one hand, to take place in regions with elastic properties and, at the same time, for the fixing to take place in a supporting ring with inelastic properties, so that cell-internal absorption of forces is possible and overall the demands imposed on the end plates and their clamping are reduced. This is possible because supporting functions are produced by the plastic material used at certain locations.

In the configurations described above, the housing used may be a simple or double-walled vessel. In this context, insulation options may play a role, so that in the double-walled configuration, for example, the cavity is filled with a phase change material, preferably with paraffin. In the case of the open stack configuration with housing and the application of pressure in the housing, the housing must be pressure-stable.

The invention improves the thermal stability of the known stack configuration and makes it possible to increase the operating temperature to up to 300° C. Therefore, a stack of this type can be used with PEM fuel cells which, in a specific embodiment, are operated at operating temperatures in this range and are referred to as HT-PEM fuel cells. To delineate them from PEM fuel cells with operating temperatures of approx. 60° C., HT-PEM fuel cells have operating temperatures of between 80 and 300° C. The use of corrosive phosphoric acid in PEM fuel cells of this type means that the choice of materials is particularly important in this instance.

The use of an adhesively bonding elastomer as edge seal results in internal absorption of forces in the stack, with the result that the demands imposed on the end plates with regard to flexural strength are reduced. The avoidance of direct contact between the bipolar plate and the membrane can increase the service life of the terminal plate considerably, since there is no risk of corrosion from acids which are stored in the membrane.

We claim:

1. A fuel cell stack, comprising:
at least two stacked fuel cell units;
two end plates;
at least one casing configuration selected from the group consisting of two outermost terminal plates, two outermost bipolar plates and a housing; and
at least one connecting material for connecting said at least two stacked fuel cell units to one another, said at least one connecting material having sealing properties as well as fixing properties.

2. The fuel cell stack according to claim 1, wherein said at least one connecting material is a thermally stable plastic.

3. The fuel cell stack according to claim 1, wherein said at least one connecting material adhesively bonds said at least two stacked fuel cell units in a sealed manner.

4. The fuel cell stack according to claim 1, wherein said at least one connecting material is an elastomer.

5. The fuel cell stack according to claim 1, wherein said at least one connecting material is an elastomer having partially elastic sections.

6. The fuel cell stack according to claim 1, wherein said at least one connecting material is an elastomer having elastic sections and partially elastic sections.

7. The fuel cell stack according to claim 6, wherein said at least one connecting material is at least partially reinforced with fibers.

8. The fuel cell stack according to claim 6, wherein said at least one connecting material has crosslinked sections.

9. The fuel cell stack according to claim 1, wherein said at least two stacked fuel cell units each include a membrane and a terminal plate, said membrane and said terminal plate do not directly contact one another.

10. The fuel cell stack according to claim 1, wherein said at least one connecting material is formed as at least one ring selected from the group consisting of a supporting ring and a sealing ring.

11. The fuel cell stack according to claim 1, wherein said housing is a pressure-carrying outer housing.

12. The fuel cell stack according to claim 1, including:
tie rods for holding together said endplates;
said at least two stacked fuel cell units having an axial supply duct; and
at least one of said tie rods being guided in said axial supply duct.

13. A method for assembling a fuel cell stack, the method which comprises:
providing at least two stacked fuel cell units, two end plates, at least one casing configuration selected from the group consisting of two outermost terminal plates, two outermost bipolar plates and a housing; and connecting the at least two stacked fuel cell units to one another by using a connecting material having a sealing property as well as a fixing property.

14. The method according to claim 13, which comprises:
sealing the at least two stacked fuel cell units by using elastic properties of the connecting material; and fixing the at least two stacked fuel cell units by using non-elastic properties of the connecting material.

15. The method according to claim 13, which comprises sealing the at least two stacked fuel cell units with an inelastic connecting material by using a bonding process.

16. A method of using a fuel cell stack, the method which comprises:
providing a fuel cell stack having at least two stacked fuel cell units, two end plates, at least one casing configuration selected from the group consisting of two outermost terminal plates, two outermost bipolar plates and a housing, the at least two stacked fuel cell units being connected to one another with a connecting material having a sealing property as well as a fixing property; and
using the fuel cell stack as a HT-PEM fuel cell stack.
